(19) United States
(12) Patent Application Publication
(10) Pub. No.: US 2026/0310680 A1
(43) Pub. Date: Oct. 8, 2026

(54) METHOD AND/OR SYSTEM FOR INTEGRATED ELECTRONIC RECORDS PROCESSING

(71) Applicant: Finity Inc., Portland, OR (US)

(72) Inventor: Justin McCormick, Portland, OR (US)

(21) Appl. No.: 19/544,824

(22) Filed: Feb. 19, 2026

Related U.S. Application Data
(60) Provisional application No. 63/760,555, filed on Feb. 19, 2025.

(51) Int. Cl. G06F 16/25

(52) U.S. Cl. CPC G06F 16/258

(57) ABSTRACT

Example methods, apparatuses, and/or articles of manufacture are disclosed herein that may be utilized in connection with one or more computing devices to facilitate and/or support one or more operations and/or techniques for electronic infrastructure for integrated electronic records processing, which may include electronic processing of file formats for healthcare or like domains that may be subject to regulatory or other compliance mandates, such as implemented, in whole or in part, in connection with one or more computing and/or communication networks and/or protocols.

### CROSS-REFERENCE TO RELATED APPLICATIONS

The present non-provisional patent application claims priority to, and the benefit of, under 35 U.S.C. § 119 to U.S. Provisional Application Ser. No. 63/760,555, entitled “METHOD AND/OR SYSTEM FOR INTEGRATED ELECTRONIC RECORDS PROCESSING,” filed on Feb. 19, 2025, which is assigned to the assignee hereof and is expressly incorporated herein by reference in its entirety.

### BACKGROUND

### Field

The present disclosure relates generally to electronic processing infrastructures and, more particularly, to electronic infrastructure for integrated electronic records processing that may be implemented, in whole or in part, in connection with network-related communications, such as to facilitate and/or support electronic processing one or more file formats for healthcare or other domains that may be subject to regulatory or other compliance mandates, which may include, for example, one or more Electronic Data Interchange (EDI) formats.

### Information

As more businesses, industries, or other domains utilize electronic communications, processing, storing, retrieving, etc. of electronic and/or digital content, a number of compliance and/or like standards or criteria have been developed by regulatory bodies or like organizations for communicating, processing, storing, retrieving, etc. various types of electronic records (e.g., file formats, etc.). This or like standards are typically intended to facilitate and/or support more secure as well as more effective and/or more efficient electronic communication, processing, storing, retrieving, etc. by a sender and/or recipient (e.g., a client device, server device, computing device, etc.). By structuring and/or formatting electronic records in a particular way, such as by a sender during or before communicating it to another computer device, for example, a recipient may be able to process, such as recognize, store, transform, etc. various received files and/or file elements in a received electronic message, such as with little or no human intervention. Many computerized data transactions typically follow various prescribed data exchange formats and/or standards, such as in connection with particular electronic data interchange, as one example, to address specific needs of various industries, so that the communicated electronic content may be recognized (e.g., understood on a computer level, etc.) by different parties to an underlying transaction (e.g., in connection with a text message, e-mail, communication, etc.). Depending on the industry, electronic data interchange may be performed by transporting physical media, such as a solid-state drive or other electronic storage media, for example, and, in some instances, may be implemented, in whole or in part, over wired and/or wireless communications networks, such as via the Internet, Intranet, and/or the like.

In some instances, minimizing or avoiding human intervention, such as while implementing the above or like aspects, for example, may often be considered a desirable goal, such as with respect to particular standards and/or industry. At times, some human intervention may be useful, for example, such as to resolve error conditions, for backend reviews or audits, and/or for like situations. Formatting content via one or more suitable standards can also facilitate and/or support electronic data interchange and/or related processing between parties, including transmission, message flow, documents and/or files mapping, content interpreting processes work with different entities, computer systems, technologies, etc. Unfortunately, differing requirements (e.g., business, regulatory, domain-specific, etc.) and/or internal data storage processes may still result in exchange or communication of inconsistently formatted records that may need to be converted, mapped, remapped, etc. to a different or more suitable file format, for example, such as while processing electronic records.

In some instances, graphical mapping tools, such as Altova®, just to name one example, may be utilized for file conversion, mapping, remapping, etc., but these or like processes are often cumbersome, complicated, and, as such, less effective and/or less efficient, and may be more difficult to understand and/or implement, even with the aid of their graphical representations and/or interfaces. More specifically, in many instances, due, at least in part, to these or like complexities, Altova® may make files or records generating, processing, mapping, remapping, tracking, modifying, etc. more cumbersome and/or more difficult to understand and/or debug, is suitable. Furthermore, there may be additional requirements that certain electronic records comply with specific privacy regulations, such as the Health Insurance Portability and Accountability Act (HIPAA), as one particular example, covering secure transmission, handling, storage, etc. of certain clinical and administrative data in the healthcare domain. In addition to these or like compliance issues, at times, processing of specially formatted electronic records, such as Electronic Data Interchange (EDI) records, for example, may force entities to process incoming, received, mapped, etc. files one line or one record at a time, thus, resulting in a relatively slower and/or less efficient process, which may be particularly problematic for domains where larger volumes of electronic records may be handled, such as health care, online commerce, or the like. Accordingly, how to more efficiently and/or more effectively facilitate processing (e.g., transmit, receive, store, map, remap, organize, read, etc.) of electronic records and/or other interchange or like content, including content specifically formatted for a particular industry, regulated or otherwise, for example, continues to be an area of development.

### BRIEF DESCRIPTION OF THE DRAWINGS

The claims provided in this application are not limited by the examples provided in the specification or drawings, but their organization and/or method of operation, together with features, and/or advantages may be best understood by reference to the examples provided in the following detailed description and in the drawings, in which:

FIG. 1 is a diagram illustrating computerized server for integrated electronic records processing, in an operating environment, consistent with an example embodiment.

FIG. 2 is another diagram of a computerized system for processing electronic files or records, consistent with an example embodiment.

FIG. 3 is a flow diagram of an electronic file parsing process, consistent with an example embodiment.

FIG. 4 is a flow diagram of an electronic file collection process, consistent with an example embodiment.

FIG. 5 is a flow diagram of an electronic file transformation process, consistent with an example embodiment.

FIG. 6 is a flow diagram of an electronic file parsing output process, consistent with an example embodiment.

FIG. 7 is a diagram illustrating computer-readable instructions for processing a particular Electronic Data Interchange (EDI) file, consistent with an example embodiment.

FIG. 8 shows a block diagram of a computing environment for integrated electronic records processing, consistent with an example embodiment.

Reference is made in the following detailed description to accompanying drawings, which form a part hereof, wherein like numerals may designate like parts throughout that are corresponding and/or analogous. The figures have not necessarily been drawn to scale, such as for simplicity and/or clarity of illustration. For example, dimensions of some aspects may be exaggerated relative to others. Other embodiments may be utilized, and structural and/or other changes may be made without departing from what is claimed. Directions and/or references, for example, such as up, down, top, bottom, and so on, may be used to facilitate discussion of drawings and are not intended to restrict application of claimed subject matter. The following detailed description therefore does not limit the claimed subject matter and/or equivalents.

### DETAILED DESCRIPTION

In the following detailed description of example embodiments, reference is made to specific example embodiments by way of drawings and illustrations. These examples are described in sufficient detail to enable those skilled in the art to practice what is described and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to aid in understanding these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, particular features, structures, characteristics, and/or the like described are capable of being combined in various ways in one or more implementations and/or embodiments and, therefore, are within intended claim scope. In general, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

As mentioned above, as more businesses, industries, or other domains utilize electronic communications, processing, storing, retrieving, etc. of computerized content, a number of standards or like criteria have been developed for communicating, processing, storing, retrieving, etc. various types of electronic records (e.g., file formats, etc.) to facilitate and/or support more effective and/or more efficient electronic processing, storing, retrieving, etc. by a recipient (e.g., a client device, server device, computing device, etc.). By structuring formatting electronic records in a particular way, such as during or before communicating it to another computer device, for example, a recipient may be able to process, such as recognize, store, transform, etc. various received files and/or file elements in a received file and/or message, such as with little or no human intervention. Many such computerized data transactions follow various data exchange formats or standards, such in connection with particular electronic data interchange, for example, to address specific needs of various industries, so that they may be understood by different parties to a transaction. Depending on the industry, electronic data interchange may be performed by transporting physical media, such as a solid-state drive or other electronic storage media, may be implemented over networks, such as the Internet, or the like.

In some instances, minimizing or avoiding human intervention, such as while implementing the above or like aspects, for example, may often be considered a desirable goal, such as with respect to particular standards and/or industry. At times, some human intervention may be useful, for example, such as to resolve error conditions, for backend reviews or audits, and/or for like situations. Formatting content via one or more suitable standards can also facilitate and/or support electronic data interchange and/or related processing between parties, including transmission, message flow, documents and/or files mapping, content interpreting processes work with different entities, computer systems, technologies, etc. Unfortunately, differing requirements (e.g., business, regulatory, domain-specific, etc.) and/or internal data storage processes may still result in exchange or communication of records that are to be converted, mapped, remapped, etc. to a different file format, such as while processing electronic records.

In some instances, graphical mapping tools, such as Altova®, just to name one example, may be utilized for file conversion, mapping, remapping, etc., but these or like processes are often cumbersome, complicated, and, as such, less effective and/or led efficient and may be more difficult to understand and/or implement, even with the aid of their graphical representations and/or interfaces. More specifically, in many instances, due, at least in part, to these complexities, Altova® may make files or records generating, processing, mapping, remapping, tracking, modifying, etc. more difficult to understand and/or debug, if warranted. Furthermore, there may be requirements that certain electronic records comply with specific privacy regulations, such as the Health Insurance Portability and Accountability Act (HIPAA) covering secure transmission, handling, storage, etc. of certain clinical and administrative data in healthcare domain. In addition to these or like compliance issues, at times, processing of specially formatted electronic records, such as EDI records, for example, may force entities to process incoming, received, mapped, etc. files one line or one record at a time, resulting in relatively slow and inefficient process, which may be particularly problematic for domains where larger volumes of electronic records are handled, such as health care domains, online commerce domains, or the like. Accordingly, how to more efficiently and/or more effectively process (e.g., transmit, receive, store, map, remap, organize, read, etc.) electronic records and/or other interchange or like content, including content specifically formatted for a particular industry, for example, continues to be an area of development.

As alluded to previously, in some instances, transmitting, storing, processing, etc. particular files or records may be subject to regulatory compliance framework, such as mandated by legislation or other governing body. For example, healthcare compliance and electronic healthcare records legislation mandates that handling (e.g., storing, transmission, processing, etc.) of certain clinical and/or administrative records in healthcare domains be in an applicable EDI (Electronic Data Interchange) format, such as HL7, X12, etc. Given the volume and complexity of such records as well as a variety of different EDI file formats, processing healthcare compliance records to convert, map, etc. to and from one or more other file formats, including from an intermediate EDI format, for example, may be challenging.

By sending content in a format compliant with an EDI standard, the receiving computer can recognize various data elements in a received file or message using the EDI standard, and can process or store the data without human intervention. Electronic Data Interchange may often be implemented, at least in part, in as an integrated environment, in which data is automatically requested by a receiving computer or automatically sent by an originating computer to facilitate automated periodic exchange of electronic data. In some integrated environments, a computerized system may be integrated for a particular entity and in which all files have a same or compatible formatting for ease of processing—e.g., all files integrated in EDI X12 formats. A non-integrated environment (e.g., intermediate EDI, non-EDI, etc.) may include a computing environment having a variety of different formats for various computer programs/processes, such as where data may be retrieved from a relational database, custom files, or the like.

“Electronic content,” “on-line content,” or like terms should be interpreted broadly and refer to signals, such signal packets, for example, and/or states, such as physical states on a memory device, for example, but otherwise is employed in a manner irrespective of format, such as any expression, representation, realization, and/or communication, for example. Content may comprise, for example, any data, information, knowledge, and/or experience, such as, again, in the form of signals and/or states, physical or otherwise. In this context, “electronic” or “on-line” content refers to content in a form that although not necessarily capable of being perceived by a human, (e.g., via human senses, etc.) may nonetheless be transformed into a form capable of being so perceived, such as visually, haptically, and/or audibly, for example. Non-limiting examples may include text, audio, images, video, security parameters, combinations, or the like. Thus, content may be stored and/or transmitted electronically, such as before or after being perceived by human senses. In general, it may be understood that electronic content may be intended to be referenced in a particular discussion, although in the particular context, the term “content” may be employed for ease of discussion. Specific examples of content may include, for example, computer code, metadata, message, text, audio file, video file, data file, web page, or the like. Claimed subject matter is not intended to be limited to these particular examples, of course.

For purposes of explanation, the X12 Electronic Data Interchange format is an ANSI standard that specifies various schemas and transaction sets that define standards for reporting various commercial transactions in such integrated environments, while similar EDI formats such as UN/EDIFACT and others are used similarly throughout the world. The X12 transaction set list includes a number of families of transaction standards, such as X12F for finance standards, X12M for supply chain standards, and X12N for insurance standards. The X12N family of insurance transactions includes transactions such as making a health care insurance claim using standard 837, making health care claim payments using standard 835, and benefit enrollment and maintenance using standard 834.

In some instances, a health insurance claim made using X12N standard 837 may involve encoding information such as the health insurance subscriber, the patient, the destination payer (or paying health insurance company), the provider receiving payment, initial and follow-up visit details, and charges. An electronic route code is typically also included, identifying the sender (the billing provider) and the receiver (the insurance company). Other information such as a transaction header and trailer identify the beginning, end, and nature of the transaction.

Depending on a standard, information may be encoded using specific codes denoting certain content, separated by asterisks within a line and by line breaks between data elements. In one specific example, a claim may be identified by a string starting with the characters “CLM” such as, for example:
CLM*26463774*100***11:B:1*Y*A*Y*I~

And an example health care diagnosis code may be identified by a string such as, for example:
HI*BK:0340*BF:V7389~

At times, coding of information may be more efficient in that it uses shortened standardized and recognized codes to identify elements of a claim such as services provided, the nature of a diagnosis, and other such information to facilitate efficient storage and transmission of health insurance claim information, but the encoded information may be difficult for human readers to manage. Although minimizing human intervention is often a desired part of integrated electronic data exchange systems, humans may typically still be responsible for managing such computerized systems to process incoming records to produce a desired record set such as updating an insurance customer's records or to perform desired actions such as paying a claim. Processing one or more EDI file formats, including parsing or extracting file contents from an EDI format file for use in a non-integrated environment, such as to populate a database or construct a table or file for a specific end use, for example, may be desirable in many applications and/or domains because it may allow for easier use of the data with in-house or legacy software or tools, with other commercial software, or with modern database tools.

Just to illustrate one particular aspect, processing file content in a single line of legacy EDI formats, such as X12N standard 837 may be challenging. As described above, to at least partially address these or like challenges, a number of available computerized tools may map incoming data to desired record locations in a database and/or output data file generated while processing a received data file. Some data mapping tools such as Altova® MapForce® software are commercially available to facilitate such mapping, but such mappings are often complex and difficult to implement, even with the aid of graphical representations and interfaces. Generating initial mappings can be difficult to manage or debug, and tracking or modifying operation of a mapping can be increasingly complex. Mapping legacy EDI formatted files also typically involves processing incoming data received as data files, such that the received files are processed one line or record at a time. This can result in relatively slow and inefficient data intake where large volumes of data may be processed, such as, for example, with health care providers, online commerce sites, or the like.

Some examples presented herein therefore provide electronic record interchange processing systems and methods that have improved efficiency, which may include a parser that may work with one or more other processes to parse, extract, validate, etc. the original coded information from a legacy data interchange format such as, for example, an EDI standard X12 data file rather than relying on mapping to transfer data from one field to another. In some instances, employing a suitable parser, such as in connection with an applicable parsing library to parse incoming content can be done more quickly and more efficiently than traditional mapping (e.g., line-by-line, etc.), and validation and normalization can help incoming data to be suitably valid and in a desired format. Parsed content may then be stored in a database, output to one or more output files, and/or otherwise employed as needed in modern software end user environments.

In at least one example, a set of integrated electronic records may, for example, be electronically processed for use, at least in part, in a non-integrated electronic environment. At least one record of a set of integrated electronic records in a first format may be accessed via a communications network, for example, and the record or records in the first format may be electronically transformed into at least one record in a second format compatible with the non-integrated electronic environment. An electronic transformation may be based, at least in part, on a parsing library predefined for a set of integrated electronic records or for a data interchange format of the electronic records. A mapping of a record or records in a first format to at least one record in a second format may be created based, at least in part, on a mapping design, for example, and at least one record in the second format may be normalized into a series of different formats comprising a mapping. In a further example, electronically transforming a record or records using a parsing library may be performed with minimal or no human intervention. A record or records in a second format may be in a modern format usable in a non-integrated environment such as application-specific files, database tables such as keyed relational database tables, markup language formats such as XML, or the like. Records in some examples may be legacy-format health care records such as X12, HL7, or other such Electronic Data Interchange files, and may be encrypted before being sent across a communication network and/or while stored to ensure compliance with the Health Insurance Portability and Accountability Act (HIPAA) and similar data privacy and security rules.

Accessing records via a communication network in some examples may include accessing a suitable server (e.g., a remote server, etc.) via Secure File Transfer Protocol (SFTP) or the like, and may be done on a periodic basis such as by periodically searching a designated directory on the server for one or more files meeting certain criteria such as a matching file name or content for automated download and processing. Records that are parsed and transformed into a second format may further be normalized and/or validated. As one particular example, various date or telephone number formats may be converted to a selected syntax, for example, so that semantic data, such as birth dates, etc. may fall into a likely range, and/or the like.

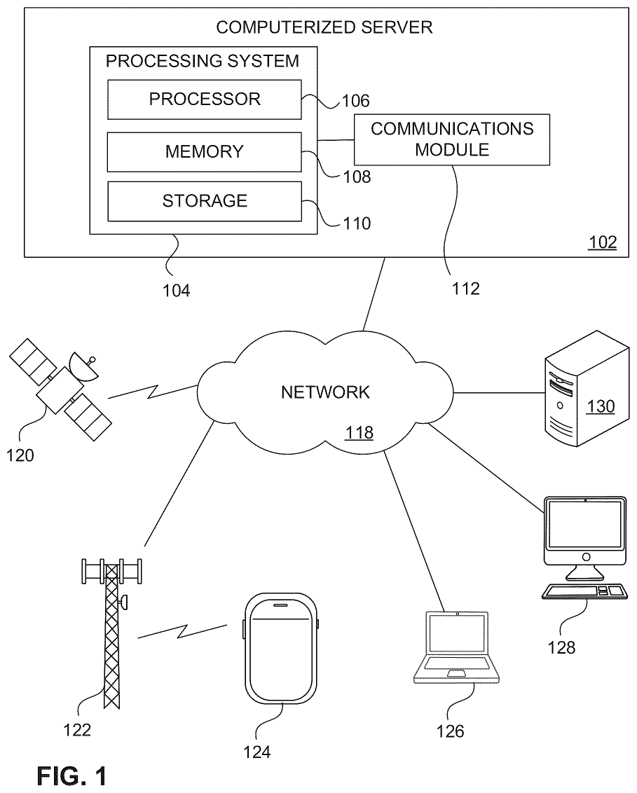

FIG. 1 is a block diagram showing computerized parsing server in an operating environment, consistent with an example embodiment. A computerized server 102 may include a parsing system for processing or parsing data, including a processor 106, a memory 108, and a storage 110. The processor 106 may execute software instructions loaded from storage 110 int memory 108, such as to implement various parsing functions and the like described in the examples presented herein. The processor may in further examples process computer instructions to perform various additional tasks or functions, such as to compress, decompress, encrypt, or decrypt files, to execute a logging and reporting system for logging and reporting results of parsing system operations, and for communicating with other computerized systems. In a further example, a communications module 112, such as a network hardware and/or software interface such as an Ethernet network connection may be employed to perform various functions, such as sending or receiving files or other information.

The computerized server 102 may be coupled to a network 118, such as a cellular telephone network, the Internet, and/or another network, over which it may communicate with other networked devices. In a more detailed example, the network 118 is coupled to one or more other computerized devices via a satellite 120, a cellular telephone system 122, or other network. The computerized server may use the network to communicate with electronic devices such as a smart phone 124, a mobile computer such as laptop computer 126, a desktop computer 128, and/or another server 130.

In a more detailed example, computerized server 102 may receive electronic files from another computer, such as files having data stored in an Electronic Data Interchange (EDI) standard format such as X12, HL7, or the like. The files may be communicated via the public network 118, such as gathering or retrieving the files from a remote server 130 via communications module 112 using a secure communications protocol such as Secure File Transfer Protocol (SFTP). The gathered files may be retrieved using a schedule, such as a cron job or the like, using a push event such as a file upload initiated by the remote compute 130, or through other such means. The gathered file may be identified by information encoded in the file name or header, such as a date associated with the file data, a sender associated with the file data, a data file type, or other such file characteristics.

Once the computerized server 102 has gathered the data file, the data file may be stored in storage 110 and parsed via processor 106, such as using a parsing library of parsing rules associated with the electronic data interchange format (such as X12N or another such data interchange format). The parsed content may be stored in one or more output data files in storage 112, stored in a relational database, or otherwise made available in a non-integrated computing environment in which the content is accessed in an application-specific format, from a database, or otherwise accessed in a format other than the standard data interchange format of the gathered file.

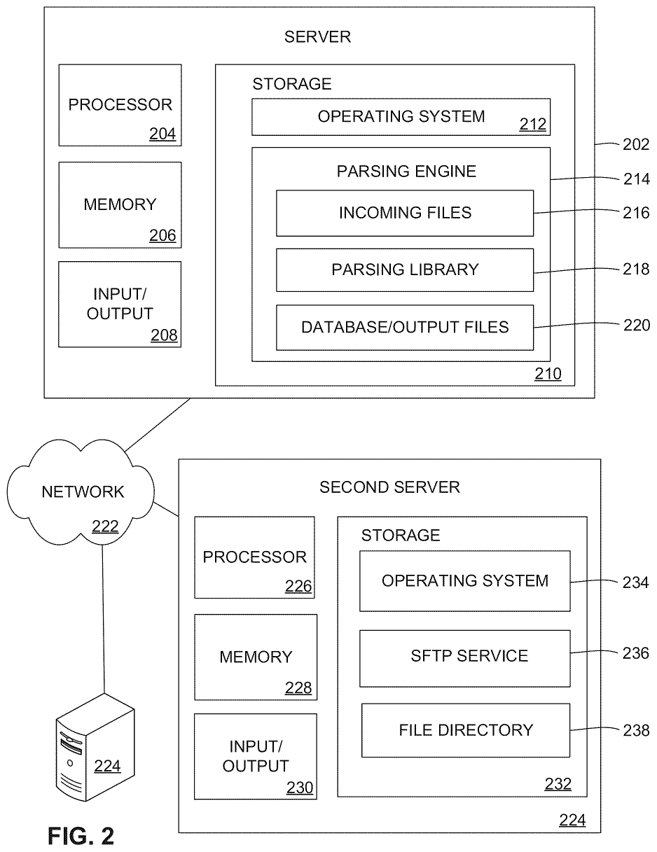

FIG. 2 is a more detailed block diagram of a computerized system to parse electronic data interchange files, consistent with an example embodiment. At 202, a server comprises a processor 204 operable to execute computer program instructions and a memory 206 operable to store information such as program instructions and other data while server 202 is operating. The server may exchange electronic data, receive input from a user, and perform other such input/output operations with input/output 208. Storage 210 may store program instructions including an operating system 212 that may provide an interface between software or programs available for execution and the hardware of the server, and may manage other functions such as access to input/output devices. The storage 210 may also store program instructions and other data for parsing engine 214, including incoming files 216, parsing library 218, and output data or content such as a database, output files, or a combination thereof at 220.

In this example, the computerized device is also coupled via a network 222 to one or more second computerized devices 224, such as a health care provider, insurance provider, or other remote client computerized device. A more detailed example of a second server 224 includes a processor 226, memory 228, and input/output 230, much as the server 202. The second server's storage 232 includes an operating system, which may include or may facilitate execution of a Secure File Transfer Protocol (SFTP) server 236, and may store one or more files in a directory 238 to be transferred.

In operation, both server 202 and second server 224 may be parties to an electronic data exchange, known in the industry as Electronic Data Interchange or EDI. In a more detailed example, remote server 224 may compile data or content to be sent to server 102 in one or more files, such as a hospital or clinic utilizing second server 224 that wants to send patient health care records to an insurance company using server 202 for billing purposes. In a further example, the insurance company may similarly send files of health care records to the hospital or clinic, such as record indicating what portion of medical care is covered by insurance and what portion of care is a patient's responsibility to pay. Exchanged files may convey electronic data such as enrollment, claim eligibility, provider information, patient information, claim status requests, health care claims, health care payments, and the like in the health care environment example described here, each using a different X12N standard (such as 835, 837, or the like).

Once an entity such as a health care provider creates an Electronic Data Interchange (EDI) file, the file may be placed in a directory 238 in storage 232 for transfer to the server 202. In further examples, different files of different types may be placed in storage 232, such as files having provider information, claim information, payment information, or other such data. The files may be identified using standardized names, embedded header data, or other such information to identify the originator, content, date, and/or other such information for the file. In one such example, a clinic named Sun Clinic may name a file having claim information as “SunClinic_claims_2024-12-31” such that the file name indicates the originator, the type of file, and the date of the file. The second server 224 may also execute a process enabling remote access to the file directory, such as Secure File Transfer Protocol (SFTP) service 136, for example, that allows remote clients or devices to log in using a username and password or similar credentials and access one or more file directories 138 for which their username or other identity has been granted access permission.

Parsing server 202 may be an insurance provider, hospital system manager, or other such entity with a business need to access EDI data generated by remote server. The parsing server in this example may periodically access files in second server 224 to retrieve EDI-formatted business records from file directory 238, such as by making periodic queries via the SFTP service 236 to search for new files meeting certain criteria such as provider, content, date, or the like. In a further example, the server 202 may hash any files identified for download and compare the hash to files already downloaded to ensure that a file is not downloaded more than once. The server 202 may check second server's file directory 238 for new files periodically (such as using a cron job or other scheduling mechanism, for example), such as hourly, daily, weekly, or the like depending on business needs.

If a new file meeting the criteria is identified in file directory 238, the file may be downloaded via SFTP and stored in incoming files storage 216. The incoming files may be queued for processing using the parsing engine 214, employing a parsing library 218 to parse and validate the file information before storing the parsed data in a database and/or as one or more output files 220. The parsing engine 214 in a further example may validate the incoming content or data, such as checking the data from the file for syntax correcting the syntax, checking the data for semantics and changing the data based on semantics, normalizing the data, or the like. In one such example, incoming phone numbers may be normalized such that various formats such as 202.123.4567, 202 123-4567, and 2021234567 are normalized or standardized to a desired format such as (202) 123-4567. Data semantics may further be validated, such as, for example, ensuring birthdates in the future or that are implausibly old are flagged as possibly erroneous, that invalid phone numbers are flagged, or the like.

The parsed and validated data stored in database/output files 220 may in various examples comprise data sets stored, at least in part, to a database, such as data records written to a file including a key field for transaction reference in a relational database where desired. Key fields may be employed to distinguish data records having elements in common from other records, such that each record has at least one unique element in a key field. In one such example, a commerce system database having records for customer names, wholesale providers, items for sale, and the like may have several item purchases per customer, several items for sale per wholesale provider, several items for sale per transaction, and the like, and so may rely on a unique key such as a unique transaction number for each sale to represent unique elements of data sets that may be of particular importance such as sale transactions in the database. Student ID numbers, account numbers, and the like may be similarly used in other contexts as a unique key, for example, helping distinguish students or customers with the same name from one another while making certain database queries. The output files may be added, at least in part, to a relational database, may be provided as reports, may be imported into other software for further processing, or may otherwise be used as the parsing server's owners or operators desire.

The parsing library 218 in a more detailed example may be operable to parse a legacy EDI format, such as X12N insurance records, UN/EDIFACT, HL7, or other such electronic data interchange formats. As discussed previously herein, many legacy EDI formats comprise character strings that encode data in a manner that may be difficult for a person to read but that are efficient for data storage and transmission, such as:
CLM*26463774*100***11:B:1*Y*A*Y*I~
HI*BK:0340*BF:V7389~
   which are example lines from an X12N 837 standard file. These lines may be parsed, for example, using a parsing engine 214 and parsing library 218 that are configured to recognize and understand the syntactic elements of the character strings and extract the data or semantic content embedded therein. The parsing may be performed automatically with little to no human intervention if a sufficiently complete parsing library is assembled. Parsing in a further example may be more difficult to set up than a mapping system due to the complexity of building a robust parsing library 218, but may result in a data processing or transformation system that is easier to understand, modify, and process than a mapping-based system.

Content or data that may not be needed in the output, such as patient home address or email address when reimbursing a clinic for an insurance claim, may further be discarded while other desired data may be kept, because the parsed data is both extracted and understood using the parsing library and the parsing engine. In another example, parsing data from an incoming or downloaded EDI file may not result in a one-to-one output of data, but may include multiple output records or files per parsed data element such as, for example, a file of records for insurance claims not yet submitted, insurance claims previously submitted but resubmitted with modified claims, a list of all insured people and their associated claims, and the like. Each output data file may therefore contain some data in common parsed from a data file via parsing engine 214, but may be assembled based on specific business needs or transaction characteristics based on the server 202 owner or operator's business needs. Similarly, records from multiple EDI files may be combined into single records in some examples such as importing multiple downloaded and processed files, at least in part, into a single relational database, resulting in a many-to-one data storage process.

The incoming files 216 retrieved via SFTP from second server 224 in some examples may contain health care records or data subject to Health Insurance Portability and Accountability Act (HIPAA) data privacy and security requirements, such as where a party to the electronic data interchange exchange is a covered entity, such as a health care provider, a health insurance plan or other managed care organization, or a health care data processor that handles health care data on behalf of such an organization. Covered entities may be required to protect the confidentiality, integrity, and availability of protected health information, which may generally include any individually identifiable health information relating to an individual's physical or mental health. Information such as the outgoing files stored in file directory 238 or transmitted over a network 222 such as the Internet may therefore be encrypted in some embodiments, such as using the SFTP protocol for network transmission and/or various encryption methods to encrypt and decrypt the data files, preserving the privacy of the data or records stored therein. Parsed data in server 202 may further be protected, such as by encrypting output files 220, encrypting a database 220 into which parsed data is stored, logging access to records within the database 220, and the like.

The parsing library 218 may in some examples may have additional parsing rules added, may have parsing rules changed or updated, or may be otherwise modified such as to perform new functions or to resolve parsing errors, for example. Although the parsed data may be difficult to read by hand, adding new parsing rules or finding applicable parsing rules and modifying them may be significantly easier than modifying complex mapping schemas using legacy systems that don't parse incoming data. Further, parsed data may be more accurate and more useful to an end user than data that is simply mapped, and data validation after parsing may help ensure that incoming data is formatted correctly and has the expected content.

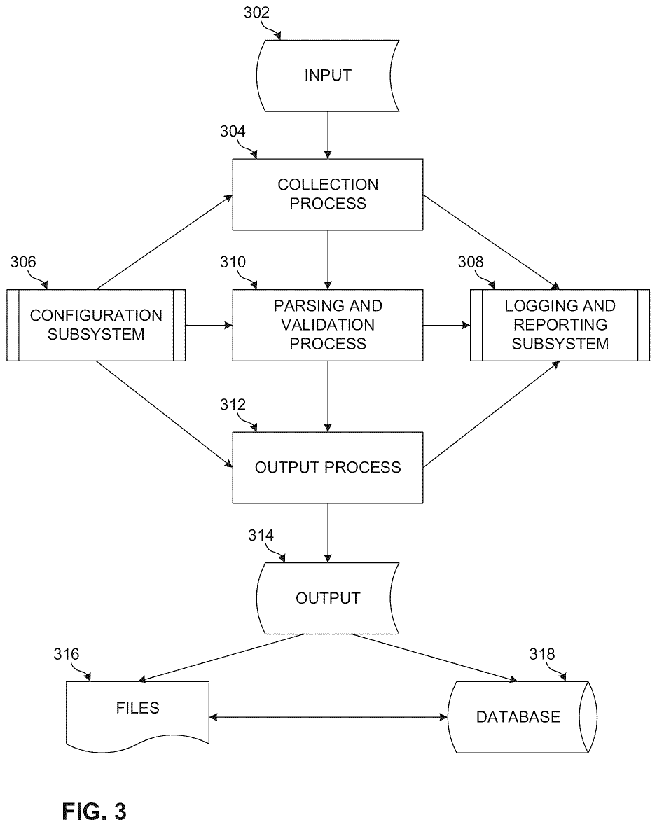

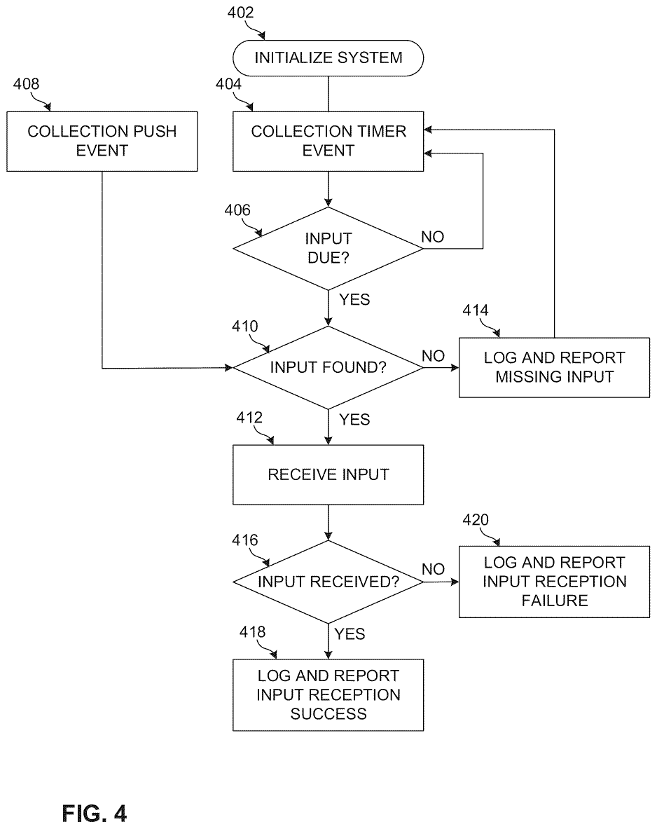

FIG. 3 is a flow diagram of an electronic data interchange file parsing process, consistent with an example embodiment. Here, the overall process from data file input to parsed and validated data output is shown, including a configuration subsystem and a logging and reporting subsystem. More detailed examples of many steps in the flow diagram of FIG. 3 are presented in FIGS. 4-6, and various elements from those examples may be integrated into various embodiments of the system presented here. The content or data may be gathered or provided as input at 302, such as, for example, a health care provider inputting claims data or records to be sent to an insurance company for reimbursement of expenses incurred in providing health care. The data in some examples is stored in a standardized electronic data interchange format file, such as X12, HL7, or another file format using standardized data encoding that can be parsed by a file recipient.

The content may be collected in a collection process at 304, such as by searching for a file on a remote server and retrieving it via SFTP, by receiving a “push” file sent to the data parsing system such as via a file upload or manual copying, or by other such means. The input content 302 in some examples may be collected periodically, such as based on a cron job that runs after a period of hours, days, weeks, or the like since the last data collection operation, for example. In one such example, a health care provider may gather new health care claim input content 302 and compile the data for each specific insurance provider they work with in an electronic data interchange (EDI) file format daily. An insurance company may the retrieve such EDI files periodically such as via a cron job for each hospital or clinic with which they have a business relationship. The data collection process 304 in a more detailed example may comprise, for example, accessing a server associated with each of the health care service providers, searching for a file (such as a file having today's date in the file name or meeting other such requirements), and retrieving the file via SFTP.

In a further example, the collection process may be configured by a configuration subsystem 306, such as to configure the health care providers from which input content or records are retrieved, to configure the schedule for searching for or retrieving new input data files, to configure SFTP login credentials for retrieving the input data files, and the like.

The collection process may in some further examples also use a logging and reporting system 308, such as to receive confirmation from processes such as the collection process 304 that the process has completed successfully or to receive an indication that the process has failed, at least in part. The logging and reporting subsystem may further be operable in some examples to generate reports, such as to report successful completion of instances of the process in FIG. 3 for various health care providers or other EDI data providers, or to report that the process failed at some step and to report the process element that failed. In a more detailed example, the logging and reporting system may report when an expected or scheduled data file can't be found in the expected remote server SFTP directory for three days in a row, such as by including the missing file on an error report, sending an email reflecting the details of the missing file, or the like.

The collected data file may then be processed via the parsing and validation process 310, which in a further example comprises using a parsing library of known data elements in a specific type of EDI file, such as X12N files for health insurance electronic data interchange. In a more specific example, the X12N EDI file specification may include multiple transaction sets for different purposes, such as the 837 transaction set standard for health care claims and 835 transaction set standard for health care claim payment. Other EDI standards may further exist within a transaction set standard, such as using ICD-9 or ICD-10 medical condition diagnosis codes in an 835 or 837 transaction set to reflect the nature of the health care services provided, for example.

Parsing the collected data is explained in greater detail in various other examples herein, but may include searching text strings or lines of data for known codes, characters, or the like having specific, predefined meanings. In the example of an X12N health insurance EDI file, each line of data is known as a segment and starts with a letter code indicating the content of the line. Elements in the segment are separated with asterisks (*), and are encoded in a specific order for each type of segment. The end of a segment is indicated with a tilde character (~), which indicates that the next text characters are the start of a new segment. Segments may encode a variety of types of data, including, for example, health care diagnosis, provider information, claim amount, patient identity, health insurance information, and other such data. Extracting the data from each segment of characters in an EDI record such as an X12N 837 insurance claim may therefore employ a parsing library that has been constructed to recognize these various character codes and transform them, at least in part, into usable data, such as the data associated with each character or character string in the applicable EDI standard.

Because the various elements of parsed data are known to have certain meanings based on the parsing library, the data can in some examples be validated such as by ensuring the encoded data represents a plausible or meaningful element of an expected data type. An encoded patient phone number, for example, should not have letter characters embedded therein, and an encoded birth date should fall within a plausible range of birth dates (such as not being in the future, not being 150 years old or greater, etc.). Data validation in a more detailed example may include syntax validation, semantic validation, or a combination thereof in various examples. Syntax formatting comprises validating the form or structure of content, at least in part, such as formatting phone numbers in various formats such as 202.123.4567, 202 123-4567 and 2021234567 to a normalized or desired format such as (202) 123-4567. Semantic validation comprises validating the meaning or content of the data, at least in part, such as rejecting phone numbers with letter characters, rejecting implausible birthdates, and the like.

The parsing and validation process in further examples may be configured using configuration subsystem 306, such as to parse data using certain parsing libraries, to format data to desired syntax or formats, to parse only certain data of interest, or the like. The results of parsing and/or validation may be logged and reported via logging and reporting subsystem 208, such as logging and reporting successful or unsuccessful parsing of files, records, segments, or other data elements, for example. In a more detailed example, the logging and reporting system may report failed parsing tasks such as flagging parsing errors, flagging parsed data failing a syntax or sematic validation, or the like.

The parsed and validated data may then be provided as output 314, which may be stored such as in an output file 316 and/or database 318. The output in some examples may have at least some of the data parsed at 310 omitted from the stored record, such as where a particular stored data file 316 only needs certain portions of the data for a particular purpose. In one such example, a file of disputed claims needing further review need not include most claims, and may omit certain information deemed unnecessary to make a claim dispute decision such as the patient's contact information or the like. Data stored in a data file may also be normalized, such as in the validation examples presented herein, and may be stored in formats suitable for specific purposes such as comma separated values (CSV), XML files, or the like.

In a further example, the files may be generated, at least in part, in a format suitable for importation into a database, such as files having a key field for integration into a relational database. The key field in such examples may be a field that uniquely identifies a type of record stored in the database, such as a claim number, a transaction number, or the like. Key fields may be employed to ensure that specific transactions can be individually and uniquely addressed in a relational database, such as where other data fields such as a patient, a provider, or a diagnosis may return multiple related transactions, for example.

FIG. 4 is a flow diagram of an electronic data interchange file collection process, consistent with an example embodiment. The example presented in FIG. 4 may be one more detailed embodiment of a data collection process as shown and described at 304 of FIG. 3. The collection process or system may be initialized at 402, such as starting a parsing server and executing software operable to perform the functions described herein. The parsing server may collect data based on various types of data collection events, such as a timer event, a push event, a manual data collection event, or the like.

In a collection timer event as shown at 404, a timer or clock-based trigger may cause the computing system to initiate a data collection event, such as using a cron job on a Unix-like computing system or other system supporting such time-driven events, for example. Such cron jobs may be run at fixed times, dates, intervals, or other measurements of time, or may be triggered by other software that is operable to implement time-based or periodic events. Such a process is shown generally at 406, in which the collection process continues to evaluate whether input data is due based on the time, date, period, or other time event, for example, and does not search for input records or content until it determines that input is due.

In a collection push event such as is shown at 408, the records or other such content may be provided as a file uploaded to an incoming file directory associated with a health care provider or other transaction party using SFTP or another such mechanism. In another example, the health care provider or other transaction party may initiate a collection push event through other means, such as by sending an email to the parsing server, by using an Internet web interface to request a push event or upload a file, or through other such means. The push event need not occur at a certain time and need not replace a periodic or timed collection event, but receipt of an expected set of records may in some embodiments modify the input data due time at 406 (such as where a specific time-based file is received early and need not be collected again later).

In either a collection push event or collection timer event, the collected records or content may be collected by using provided login credentials to log in to a remote server via a service such as Secure File Transfer Protocol or SFTP, and searching a directory for which the login credentials provide read permissions to search for a data file, for example. The data file may be identified for collection in various ways in various examples, such as collecting any data file present that has not been previously collected, collecting a data file having a header or file name consistent with an expected file name, or the like. In one such example, a file from a health care provider HealthProviderCo having claims information for an insurance company called InsuranceCo that are for Dec. 31, 2024 might have the expected name format “HealthProviderCo-InsuranceCo-2024-12-31,” and only files matching the expected name format may be downloaded. In other examples, the file may be downloaded if it matches the expected file name at least in part, if it has not been previously downloaded, or based on other such criteria. In some examples, additional steps may be taken to reduce the chances of collecting the same file twice, such as checking a computed hash value of the contents of a new file to ensure it doesn't match the hash value of previously collected data files.

If an expected input file is not found at 410, the data collection process may log and report the missing input data at 414, such as via the logging and reporting subsystem 308 of FIG. 3. If an expected file is not found at the input due data as determined at 406, or is not found for a certain period of time past the input due date such as being more than two days late, the logging and reporting system may generate an alert such as sending an email to associated responsible parties notifying them of the absence of the expected data file.

If at least one appropriate input file is found for collection at 410, the input file is received at 412 such as by using SFTP or another such mechanism to upload the file from the remote server to the parsing server. In some such examples, the parsing server may store login credentials for the remote server that grant it access to a directory into which a transaction party such as a health care provider is expected to store data files, providing secure communication of such files between the health care provider and a parsing server associated with an insurance company. The input file may be received in other ways in other examples, such as by being identified in an upload folder on the parsing server as a result of a data collection push event at 408, by manual data collection on machine-readable media or a network connection, or by other such means. If the input file is received correctly at 416, the data collection process may log and report input reception success at 418. If the input collection fails, at least in part, the data collection process may log and report input data reception failure at 420. In a further embodiment the logging and reporting events at 418 or 420 may be performed using a logging and reporting subsystem such as that shown at 308 of FIG. 3. In an alternate embodiment, failure to receive input at 416 may result in one or more repeated attempts to collect the input at 416 before reporting failure of the input collection or reception at 420.

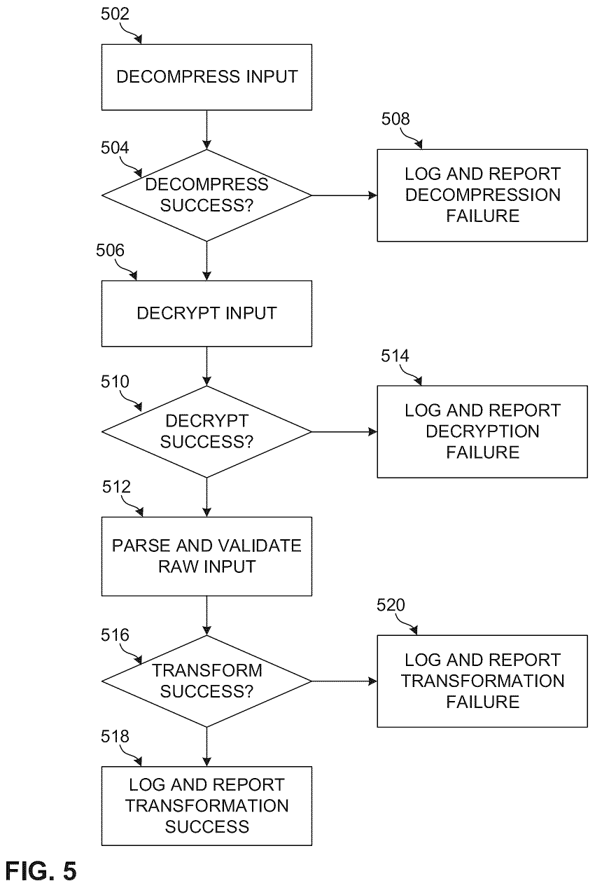

FIG. 5 is a flow diagram of an electronic data interchange file data transformation process, consistent with an example embodiment. In some example embodiments, at least some of the functions described herein may be performed at data parsing and validation process 310 of FIG. 3's overall system flow diagram. As shown here, the input received via a process such as that shown in FIG. 4 or at 304 of FIG. 3 may be compressed to save storage space and to reduce network congestion and transit time, for example. The input in some examples may also be encrypted, such as to preserve the confidentiality of the data contained in an Electronic Data Interchange or EDI file, which may be required in some transaction environments such as health care environments where HIPAA requirements may dictate certain data privacy and security standards that must be met, for example. The incoming file is first decompressed at 502, at least in part, if it is determined that the file is compressed, such as by observing a file type or extension such as .zip or .tar that is associated with a compression method or observing file header data that may similarly identify that the file is compressed. If the file decompression is successful as determined at 504, the decompressed file may be sent to 506 for decryption, and if the file decompression is determined to have failed or to have been unsuccessful, at least in part, the decompression failure may be logged and reported at 508 such as via the logging and reporting subsystem 308 of FIG. 3.

At 506, the successfully decompressed data file may be decrypted, at least in part, such as if the decompressed file has a file type extension, a file header, or other indication that the file may be encrypted. In other examples, the data parsing system configuration may indicate that incoming files are expected to be encrypted using a certain encryption scheme, and are to be decrypted. The decryption step at 506 may include using various encryption technologies in various examples, such as public/private key or asymmetric encryption, shared key or symmetric encryption, or other such data encryption standards. In some examples, the SFTP step secures data in transport over a public network using encryption technology such as Secure Sockets Layer (SSL) or Transport Layer Security (TLS), and decryption may occur as part of the file transport process. In some examples, the data decryption step 510 may occur before the decompression step 502, such as where the file transport process employed over a public network includes sufficient encryption for the transaction environment, or the decryption and decompression may occur, at least in part, at the same time.

If the decryption process succeeds at 510, the decompressed and decrypted file content may be provided for parsing and validation at 512. Parsing the content or data may comprise taking in data in a legacy format, such as an Electronic Data Interchange or EDI format of records store in an encoded manner, such as the health insurance X12N EDI format discussed in many examples presented herein, for example. Legacy formats such as X12N may be many decades old, often designed at a time when electronic data storage such as hard disk drives was many orders of magnitude more limited and more expensive than it is today. Further, data transmission between remote networked computers was many orders of magnitude slower than currently common data exchange speeds. Encoding common diagnoses using codes, for example, not only ensured use of a common descriptor for common diagnoses but greatly reduced the number of characters that were stored or transmitted across a network to record a diagnosis. Legacy formats such as X12N may therefore prioritize coding efficiency over readability or usability, whereas modern formats such as relational database tables may be vastly more readable, and may be much more readily employed to run various reports or perform other data processing functions common in modern business environments, for example.

The X12N data in one example may therefore be parsed using a parsing library to reconstitute the encoded data, at least in part, decoding segments or lines of data using knowledge of the segment structure such as separating data elements in the segment with asterisks and ending segments with a tilde character. The parsing library comprises information such as the segment content expected as a result of each segment header or initial text string, such as health care diagnosis, provider information, claim amount, patient identity, health insurance information, and other such data in an X12N 837 file, for example. The parsed data may be written, at least in part, to a file, to a database, or the like, such that it can be more readily employed by the data recipient using modern tools like relational database query tools and data processing tools.

The parse and validate raw input block 512 may in some embodiments also comprise validation of the parsed data, at least in part, such as ensuring that the syntax or form of the data is correct and verifying that the semantic content of the data is consistent with the data type. Syntax validation in a further example may comprise normalization of data, such as formatting phone numbers in various formats such as 202.123.4567, 202 123-4567 and 2021234567 to a normalized or desired format such as (202) 123-4567, ensuring that the phone number has only numbers, and ensuring that the expected number of numbers are present, for example. Semantic validation may comprise ensuring that the content of the phone number is meaningful, such as, for example, using a valid area code for a phone number or having a birth date that is not 150 years in the past or in the future.

At 516, the transformation process may evaluate whether the parsing and validation at 512 was successful or generated errors or warnings, and any such errors or warnings may be logged and reported at 520 such as via logging and reporting subsystem 308 of FIG. 3. Reports in various examples may comprise parsing errors such as unknown or unexpected data encountered while parsing, syntax errors in parsed data such as letter characters in a phone number or birthdate, semantic errors such as a birth date that is implausible, or the like. If parsing and validating the raw input data was successful, the logging and reporting system may similarly record success of the transformation process at 518. In a more detailed example, data having a parsing error, a syntax error, a semantic error, or the like may be flagged and/or output to a separate file or otherwise separated or flagged from normally parsed output data, such as for manual resolution of the parsing error or of invalid data.

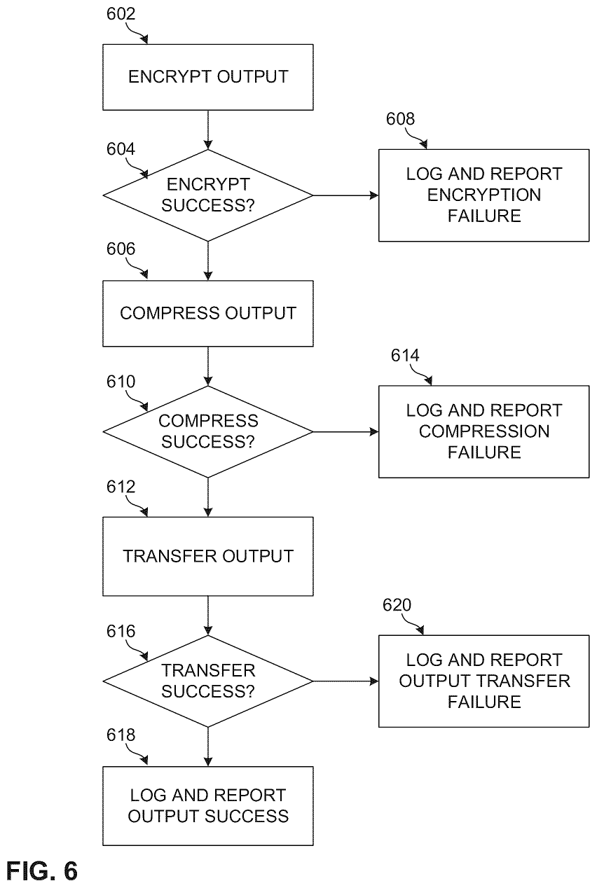

FIG. 6 is a flow diagram of an electronic data interchange file parsing output process, consistent with an example embodiment. The example presented in FIG. 6 may be one more detailed embodiment of an output process as shown and described at 314 of FIG. 3. Here, the output at the data transformation process of FIG. 5 may be, at least in part, prepared for output such as transferring to another party to an electronic transaction, stored in a modern format such as in relational database or in a file including a key field identifying unique transaction records (such as a health care claim number) for importation into a relational database, or the like.

The output may be encrypted, at least in part, at 602, such as using a private key in an asymmetric encryption algorithm, a shared or confidential key in a symmetric encryption algorithm, or another such algorithm to prevent accessing the output data without a suitable decryption key or other such credentials. In a further example, the encryption may comprise, for example, encryption built into a storage device such as storing the data on an encrypted volume with restricted access, sending the output using a data transport protocol including encryption such as SSL or TLS, or the like. If encryption succeeds, the process may continue to compress the encrypted output at 606, while if encryption fails, at least in part, the encryption failure may be logged and/or reported at 608 such as via the logging and reporting subsystem 308 of FIG. 3. In a further example, the logging and reporting subsystem may also log and/or report success of the output encryption process in addition to any errors or failure. In an alternate embodiment, the output may be compressed at 606 before being encrypted at 602, opposite the order shown in FIG. 6, or encrypting and compressing may occur, at least in part, at the same time.

The compression process at 610 may include mechanisms to reduce the size of a file, such as encoding character patterns that occur repeatedly within the file using a reduced number of characters, encoding consecutive characters such as blank spaces using a reduced number of characters, and other such compression schemes. In some examples, the compression scheme may be a common or standardized compression scheme such as a .zip or .tar file, making the compressed data file easy for another transaction party or another computer system to decompress using commonly available software. Failure and/or success of the compression process, at least in part, may similarly be logged and/or reported at 614, such as by the logging and reporting subsystem 308 of FIG. 3.

The encrypted and compressed data may be transferred at 612, such as to another computer system, to another party to an electronic transaction, to a database or file storage system, or to another such computerized system or entity, for example. The success of the data transfer may be logged and reported at 618, or may be logged and reported as a failure at 620. In some embodiments, only failure of one or more processes such as encryption and compression may be logged, but it may be desirable in some examples to log successful transfer of an encrypted and compressed output file as evidence that the encryption, compression, and transfer processes were all successful.

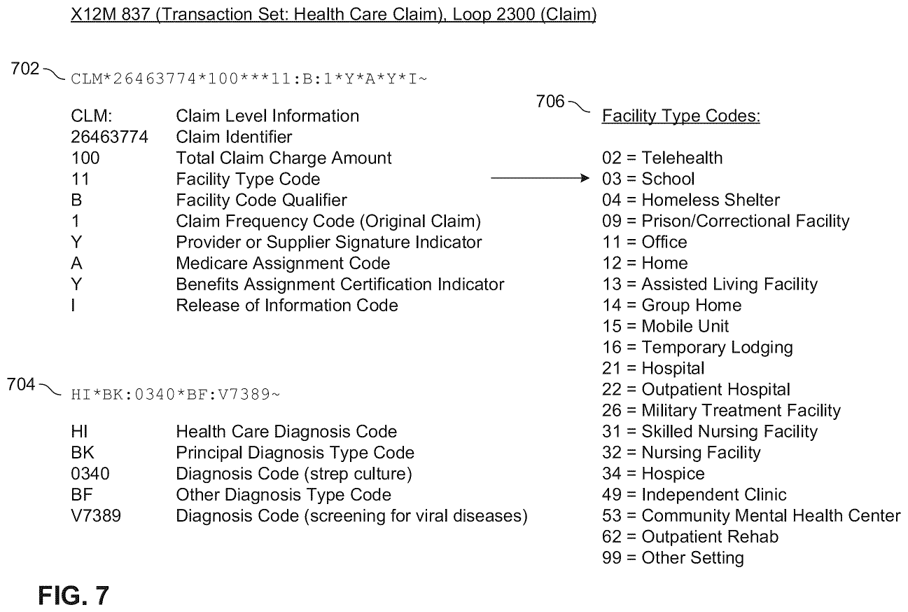

FIG. 7 is a diagram showing parsing lines of an X12 Electronic Data Interchange (EDI) file, consistent with an example embodiment. Here, two lines or segments from an X12N (Health Insurance) standard file are shown. The file in this example is an 837 file, containing one or more transaction sets related to a health care claim. The file complies with standards for X12N and for 837 transaction sets laid out by the X12 standards organization, such that they can be parsed using a parsing library constructed based on the published standards for the X12N health insurance transactions and 837 health care claim transaction sets.

The two lines presented here are further a part of a loop, or a subset, of transaction sets in the 837 health care claim transaction set. Various loops in the 837 transaction set identify groups of similar or related information such as the name, address, phone number, and other information related to the provider, information related to the identity of the patient, and other such information. The transaction set lines shown in monospace text at 702 and 704 comprise a part of loop 2300, which is a “Claim” loop that includes the nature of the medical issue diagnosis and treatment being claimed. The example presented here is an example provided by the X12 standards organization, and is parsed using information published by the standards organization.

The example segment shown at 702 starts with the characters “CLM,” which as denoted in the table below the segment reflects that the segment contains claim level information. An asterisk separates each data element of the segment from the next element, with multiple asterisks in a row where expected data elements in the segment sequence are not needed. The next data element at 702 is a string of numbers, identified in the table as a claim identifier, followed by a data element reflecting a total claim amount of $100. Two subsequent data elements in the CLM segment parsing standard are skipped or not used as reflected by the three asterisks in a row, and the next element is a facility type code indicating the nature of the facility where health care was provided.

The facility type code 11 in this example indicates that the medical services were provided in an “Office” environment, as reflected in the Facility Type Codes table at 706. Many such data elements in various segments may be similarly encoded, at least in part, using numbers or letters to represent data that may be represented or defined using a longer character string, such as using two numerical digits to represent a text description of a facility type where medical services were provided. Facility types that can be encoded using the table shown at 706 include, for example, a prison or correctional facility (type code 09), a hospital (type code 21), an outpatient rehab facility (type 62), as well as an “Other Setting” facility type of 99 for settings not covered by other elements in the table. Because some medical insurers may only cover expenses related to treatment in certain facilities (e.g., treatment in a clinic or hospital is covered but additional charges for treatment at home are not), the facility code may be a relevant part of the claim for determining payment or reimbursement to the health care provider.

Other data elements in the segment shown at 702 include a facility code qualifier, a claim frequency code, a provider or supplier signature indicator, a Medicare assignment code, a benefits assignment certification indicator, and a release of information code. The release of information code character “I” is followed by a tilde in the segment shown at 702, indicating the end of the “CLM” segment in this example.

The next line or segment in the loop 2300 (Claim) section of this X12N EDI standard (Insurance) 837 transaction (Health Care Claim) example is shown at 704, and starts with the characters “HI” indicating that it contains health care diagnosis codes. The following “BK” data element indicates that the next element comprises a principal diagnosis code, and the following diagnosis code “0340” indicates a strep culture. The next data element in the sequence “BF” indicates an other diagnosis type code is encoded in the following data element, and the next data element in the sequence “V7389” indicates screening for viral diseases. The diagnosis codes “0340” and “V7389” are in this example standard ICD-9 codes, set as a standard for International Classification of Diseases, 9^{th} revision, but in other examples ICD-10 codes reflecting the 10^{th} revision of the International Classification of Diseases or other such codes may be used. Integration of external standards such as ICD-9 or ICD-10 codes may similarly be employed for other EDI loops, transaction sets, standards, and the like on various embodiments, such as based on the type of transaction being conducted, the EDI standard being employed, and other such factors.

Electronic data interchange segments such as those shown in lines 702 and 704 may be parsed using a parsing library of information, such as the meaning of various data elements in various segments, embedded data that may be encoded using an external standard such as ICD-10 diagnosis codes, and the like. The parsing library may be somewhat difficult and time-consuming to construct relative to a mapping library, but it may be relatively easy to understand and to modify as needed such as where parsing errors are encountered or to reflect changes in the EDI standard or other standards. The parsed data in various examples may be stored or output in a format that is relatively easy for an end user to understand or to use, such as outputting “Office” as a facility type code in a database table or outputting an application-specific code for use in a non-integrated environment in which the data is desirably stored in a format other than the gathered EDI file format. In some such examples, it may be beneficial to retain one or more original EDI format codes, such as a numeric diagnosis code for example, so that the external standard code can be easily and positively identified. Such codes may be reflected as a “Principal Diagnosis Type ICD-9 Code,” “Other Diagnosis Type ICD-9 Code,” or the like in a data table to facilitate easier understanding of what the still-encoded data represents without further parsing.

The examples presented herein illustrate how legacy data formats such as Electronic Data Interchange (EDI) standard formats can be automatically parsed, with little or no human intervention, into data that may be more easily employed in modern software such as relational databases and the like. Such a system may be an improvement over mapping systems in that the parsing library is easier to understand and update than a typical mapping system, and the parsing system may be content-aware of the data being parsed such that the data can be validated, transformed, or otherwise processed before being exported or stored in a database or data file. Parsing large data files may further be significantly more efficient than mapping such files using existing tools, such that a parsing computer system such as that of FIG. 1 may utilize its full computing capacity in parsing the data file. The parsed data may in various examples be output into as many files as desired or combined into a single file with previously parsed data in a one-to-many file parsing, a many-to-one file parsing, or a combination thereof, such as for use in a non-integrated environment where data is made available formats different from the integrated EDI environment such as stored in databases or stored using custom file formats. Parsed output files may further employ a key element, such as a claim number or transaction number, enabling importation of such data into a modern relational database, making the data available to a variety of non-integrated software or services, and facilitating generation of various sophisticated reports, data analysis, and the like using the relational database.

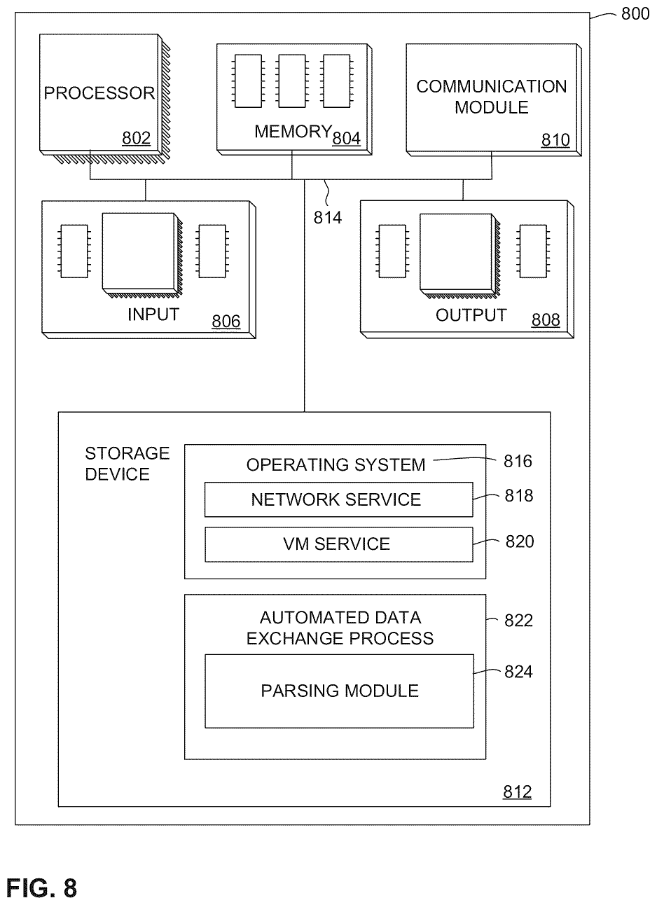

FIG. 8 shows a block diagram of a general-purpose computerized system, consistent with an example embodiment. FIG. 8 illustrates only one particular example of computing device 800, and other computing devices 800 may be used in other embodiments. Although computing device 800 is shown as a standalone computing device, computing device 800 may be any component or system that includes one or more processors or another suitable computing environment for executing software instructions in other examples, and need not include all of the elements shown here.

As shown in the specific example of FIG. 8, computing device 800 includes one or more processors 802, memory 804, one or more input devices 806, one or more output devices 708, one or more communication modules 810, and one or more storage devices 812. Computing device 800, in one example, further includes an operating system 816 executable by computing device 800. The operating system includes in various examples services such as a network service 818 and a virtual machine service 820 such as a virtual server. One or more applications, such as photo manager 822 are also stored on storage device 812, and are executable by computing device 800.

Each of components 802, 804, 806, 808, 810, and 812 may be interconnected (physically, communicatively, and/or operatively) for inter-component communications, such as via one or more communications channels 814. In some examples, communication channels 814 include a system bus, network connection, inter-processor communication network, or any other channel for communicating data. Applications such as automated data exchange process 822 and operating system 816 may also communicate information with one another as well as with other components in computing device 800.

Processors 802, in one example, are configured to implement functionality and/or process instructions for execution within computing device 800. For example, processors 802 may be capable of processing instructions stored in storage device 812 or memory 804. Examples of processors 802 include any one or more of a microprocessor, a controller, a central processing unit (CPU), a graphics processing unit (GPU), a neural processing unit (NPU), an image signal processor (ISP), a digital signal processor (DSP), an application specific integrated circuit (ASIC), a field-programmable gate array (FPGA), or similar discrete or integrated logic circuitry.

One or more storage devices 812 may be configured to store information within computing device 700 during operation. Storage device 812, in some examples, is known as a computer-readable storage medium. In some examples, storage device 812 comprises temporary memory, meaning that a primary purpose of storage device 812 is not long-term storage. Storage device 812 in some examples is a volatile memory, meaning that storage device 812 does not maintain stored contents when computing device 800 is turned off. In other examples, data is loaded from storage device 812 into memory 804 during operation. Examples of volatile memories include random access memories (RAM), dynamic random access memories (DRAM), static random access memories (SRAM), and other forms of volatile memories known in the art. In some examples, storage device 812 is used to store program instructions for execution by processors 802. Storage device 812 and memory 804, in various examples, are used by software or applications running on computing device 800 such as automated data exchange process 822 to temporarily store information during program execution.

Storage device 812, in some examples, includes one or more computer-readable storage media that may be configured to store larger amounts of information than volatile memory. Storage device 812 may further be configured for long-term storage of information. In some examples, storage devices 812 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 800, in some examples, also includes one or more communication modules 810. Computing device 800 in one example uses communication module 810 to communicate with external devices via one or more networks, such as one or more wireless networks. Communication module 810 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, computing device 800 uses communication module 810 to wirelessly communicate with an external device such as via a public network such as the Internet.

Computing device 800 also includes in one example one or more input devices 806. Input device 806, in some examples, is configured to receive input from a user through tactile, audio, or video input. Examples of input device 806 include a touchscreen display, a mouse, a keyboard, a voice responsive system, video camera, microphone or any other type of device for detecting input from a user.

One or more output devices 808 may also be included in computing device 800. Output device 808, in some examples, is configured to provide output to a user using tactile, audio, or video stimuli. Output device 808, in one example, includes a display, a sound card, a video graphics adapter card, or any other type of device for converting a signal into an appropriate form understandable to humans or machines. Additional examples of output device 808 include a speaker, a light-emitting diode (LED) display, a liquid crystal display (LCD or OLED), or any other type of device that can generate output to a user.

Computing device 800 may include operating system 816. Operating system 816, in some examples, controls the operation of components of computing device 800, and provides an interface from various applications such as automated data exchange process 822 and parsing module 824 to components of computing device 800. For example, operating system 816, in one example, facilitates the communication of various applications such as automated data exchange process 822 with processors 802, communication unit 810, storage device 812, input device 806, and output device 808. Applications such as automated data exchange process 822 may include program instructions and/or data that are executable by computing device 800. As one example, automated data exchange process 822 may implement a parsing module 824 to parse electronic data interchange format files such as is described in the examples above. These and other program instructions or modules may include instructions that cause computing device 800 to perform one or more of the other operations and actions described in the examples presented herein.

In the context of the present document, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other electrical conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, is also used to mean that two or more tangible components and/or the like are not necessarily tangibly in direct physical contact, but are able to co-operate, liaise, and/or interact, such as, for example, by being “optically coupled.” Likewise, the term “coupled” may be understood to mean indirectly connected in an appropriate context. It is further noted, in the context of the present disclosure, the term physical if used in relation to memory, such as memory components or memory states, as examples, necessarily implies that memory, such memory components and/or memory states, continuing with the example, is tangible.

Additionally, in the present document, in a particular context of usage, such as a situation in which tangible components (and/or similarly, tangible materials) are being discussed, a distinction exists between being “on” and being “over.” As an example, deposition of a substance “on” a substrate refers to a deposition involving direct physical and tangible contact without an intermediary, such as an intermediary substance (e.g., an intermediary substance formed during an intervening process operation), between the substance deposited and the substrate in this latter example; nonetheless, deposition “over” a substrate, while understood to potentially include deposition “on” a substrate (since being “on” may also accurately be described as being “over”), is understood to include a situation in which one or more intermediaries, such as one or more intermediary substances, are present between the substance deposited and the substrate so that the substance deposited is not necessarily in direct physical and tangible contact with the substrate.

A similar distinction is made in an appropriate particular context of usage, such as in which tangible materials and/or tangible components are discussed, between being “beneath” and being “under.” While “beneath,” in such a particular context of usage, is intended to necessarily imply physical and tangible contact (similar to “on,” as just described), “under” potentially includes a situation in which there is direct physical and tangible contact, but does not necessarily imply direct physical and tangible contact, such as if one or more intermediaries, such as one or more intermediary substances, are present. Thus, “on” is understood to mean “immediately over” and “beneath” is understood to mean “immediately under.”

It is likewise appreciated that terms such as “over” and “under” are understood in a similar manner as the terms “up,” “down,” “top,” “bottom,” and so on, previously mentioned. These terms may be used to facilitate discussion, but are not intended to necessarily restrict scope of claimed subject matter. For example, the term “over,” as an example, is not meant to suggest that claim scope is limited to only situations in which an embodiment is right side up, such as in comparison with the embodiment being upside down, for example. An example includes a flip chip, as one illustration, in which, for example, orientation at various times (e.g., during fabrication) may not necessarily correspond to orientation of a final product. Thus, if an object, as an example, is within applicable claim scope in a particular orientation, such as upside down, as one example, likewise, it is intended that the latter also be interpreted to be included within applicable claim scope in another orientation, such as right side up, again, as an example, and vice-versa, even if applicable literal claim language has the potential to be interpreted otherwise. Of course, again, as always has been the case in the specification of a patent application, particular context of description and/or usage provides helpful guidance regarding reasonable inferences to be drawn.

Unless otherwise indicated, in the context of the present disclosure, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Furthermore, the terms “first,” “second'” “third,” and the like are used to distinguish different aspects, such as different components, as one example, rather than supplying a numerical limit or suggesting a particular order, unless expressly indicated otherwise. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, to be understood in the following manner. As an example, in a given situation, assume a value of a physical property is to be measured. If, alternatively, reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated. As an example, if a plot of measurements over a region is produced and implementation of claimed subject matter refers to employing a measurement of slope over the region, but a variety of reasonable and alternative techniques to estimate the slope over that region exist, claimed subject matter is intended to cover those reasonable alternative techniques, even if those reasonable alternative techniques do not provide identical values, identical measurements or identical results, unless otherwise expressly indicated.

It is further noted that the terms “type” and/or “like,” if used, such as with a feature, structure, characteristic, and/or the like, using “optical” or “electrical” as simple examples, means at least partially of and/or relating to the feature, structure, characteristic, and/or the like in such a way that presence of minor variations, even variations that might otherwise not be considered fully consistent with the feature, structure, characteristic, and/or the like, do not in general prevent the feature, structure, characteristic, and/or the like from being of a “type” and/or being “like,” (such as being an “optical-type” or being “optical-like,” for example) if the minor variations are sufficiently minor so that the feature, structure, characteristic, and/or the like would still be considered to be predominantly present with such variations also present. Thus, continuing with this example, the terms optical-type and/or optical-like properties are necessarily intended to include optical properties. Likewise, the terms electrical-type and/or electrical-like properties, as another example, are necessarily intended to include electrical properties. It should be noted that the specification of the present disclosure merely provides one or more illustrative examples and claimed subject matter is intended to not be limited to one or more illustrative examples; however, again, as has always been the case with respect to the specification of a patent application, particular context of description and/or usage provides helpful guidance regarding reasonable inferences to be drawn.

With advances in technology, it has become more typical to employ distributed computing and/or communication approaches in which portions of a process, such as signal processing of signal samples, for example, may be allocated among various devices, including one or more client devices, one or more server devices and/or one or more peer-to-peer devices, via a computing and/or communications network, for example. A network may comprise two or more devices, such as network devices and/or computing devices, and/or may couple devices, such as network devices and/or computing devices, so that signal communications, such as in the form of signal packets and/or signal frames (e.g., comprising one or more signal samples), for example, may be exchanged, such as between a server device, a client device and/or a peer-to-peer device, as well as other types of devices, including between wired and/or wireless devices coupled via a wired and/or wireless network, for example.

An example of a distributed computing system comprises the so-called Hadoop distributed computing system, which employs a map-reduce type of architecture. In the context of the present disclosure, the terms map-reduce architecture and/or similar terms are intended to refer to a distributed computing system implementation and/or embodiment for processing and/or for generating larger sets of signal samples employing map and/or reduce operations for a parallel, distributed process performed over a network of devices. A map operation and/or similar terms refer to processing of signals (e.g., signal samples) to generate one or more key-value pairs and to distribute the one or more pairs to one or more devices of the system (e.g., network). A reduce operation and/or similar terms refer to processing of signals (e.g., signal samples) via a summary operation (e.g., such as counting the number of students in a queue, yielding name frequencies, etc.). A system may employ such an architecture, such as by marshaling distributed server devices, executing various tasks in parallel, and/or managing communications, such as signal transfers, between various parts of the system (e.g., network), in an embodiment. As mentioned, one non-limiting, but well-known, example comprises the Hadoop distributed computing system. It refers to an open source implementation and/or embodiment of a map-reduce type architecture (available from the Apache Software Foundation, 1901 Munsey Drive, Forrest Hill, MD, 21050-2747), but may include other aspects, such as the Hadoop distributed file system (HDFS) (available from the Apache Software Foundation, 1901 Munsey Drive, Forrest Hill, MD, 21050-2747). In general, therefore, “Hadoop” and/or similar terms (e.g., “Hadoop-type,” etc.) refer to an implementation and/or embodiment of a scheduler for executing larger processing jobs using a map-reduce architecture over a distributed system. Furthermore, in the context of the present disclosure, use of the term “Hadoop” is intended to include versions, presently known and/or to be later developed.

In the context of the present document, the term “network device” refers to any device capable of communicating via and/or as part of a network and may comprise a computing device. While network devices may be capable of communicating signals (e.g., signal packets and/or frames), such as via a wired and/or wireless network, they may also be capable of performing operations associated with a computing device, such as arithmetic and/or logic operations, processing and/or storing operations (e.g., storing signal samples), such as in a non-transitory memory as tangible, physical memory states, and/or may, for example, operate as a server device and/or a client device in various embodiments. Network devices capable of operating as a server device, a client device and/or otherwise, may include, as examples, dedicated rack-mounted servers, desktop computers, laptop computers, set top boxes, tablets, netbooks, smart phones, wearable devices, integrated devices combining two or more features of the foregoing devices, and/or the like, or any combination thereof. As mentioned, signal packets and/or frames, for example, may be exchanged, such as between a server device and/or a client device, as well as other types of devices, including between wired and/or wireless devices coupled via a wired and/or wireless network, for example, or any combination thereof. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description, a network device (also referred to as a networking device) may be embodied and/or described in terms of a computing device and vice-versa. However, it should further be understood that this description should in no way be construed so that claimed subject matter is limited to one embodiment, such as only a computing device and/or only a network device, but, instead, may be embodied as a variety of devices or combinations thereof, including, for example, one or more illustrative examples.

A network may also include now known, and/or to be later developed arrangements, derivatives, and/or improvements, including, for example, past, present and/or future mass storage, such as network attached storage (NAS), a storage area network (SAN), and/or other forms of device readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be substantially compliant and/or substantially compatible with differing protocols, such as network computing and/or communications protocols (e.g., network protocols), may interoperate within a larger network.

In the context of the present document, the term sub-network and/or similar terms, if used, for example, with respect to a network, refers to the network and/or a part thereof. Sub-networks may also comprise links, such as physical links, connecting and/or coupling nodes, so as to be capable to communicate signal packets and/or frames between devices of particular nodes, including via wired links, wireless links, or combinations thereof. Various types of devices, such as network devices and/or computing devices, may be made available so that device interoperability is enabled and/or, in at least some instances, may be transparent. In the context of the present disclosure, the term “transparent,” if used with respect to particular communicating devices of a network, refers to the devices communicating via the network in which the devices are able to communicate via one or more intermediate devices, such as of one or more intermediate nodes, but without the communicating devices necessarily specifying the one or more intermediate nodes and/or the one or more intermediate devices of the one or more intermediate nodes. Thus, a network may include the one or more intermediate nodes and/or the one or more intermediate devices of the one or more intermediate nodes in communications and the network may engage in communications via the one or more intermediate nodes and/or the one or more intermediate devices of the one or more intermediate nodes, but the network may operate as if such intermediate nodes and/or intermediate devices are not necessarily involved in communications between the particular communicating devices. For example, a router may provide a link and/or connection between otherwise separate and/or independent LANs.

In the context of the present document, a “private network” refers to a particular, limited set of devices, such as network devices and/or computing devices, able to communicate with other devices, such as network devices and/or computing devices, in the particular, limited set, such as via signal packet and/or signal frame communications, for example, without a need for re-routing and/or redirecting signal communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet. Although signal packet and/or frame communications (e.g. signal communications) may employ intermediate devices of intermediate nodes to exchange signal packets and/or signal frames, those intermediate devices may not necessarily be included in the private network by not being a source or designated destination for one or more signal packets and/or signal frames, for example. It is understood in the context of the present disclosure that a private network may direct outgoing signal communications to devices not in the private network, but devices outside the private network may not necessarily be able to direct inbound signal communications to devices included in the private network.

The Internet refers to a decentralized global network of interoperable networks that comply with the Internet Protocol (IP). It is noted that there are several versions of the Internet Protocol. The term Internet Protocol, IP, and/or similar terms are intended to refer to any version, now known and/or to be later developed. The Internet includes local area networks (LANs), wide area networks (WANs), wireless networks, and/or long haul networks that, for example, may allow signal packets and/or frames to be communicated between LANs. The term World Wide Web (WWW or Web) and/or similar terms may also be used, although it refers to a part of the Internet that complies with the Hypertext Transfer Protocol (HTTP). For example, network devices may engage in an HTTP session through an exchange of appropriately substantially compatible and/or substantially compliant signal packets and/or frames. It is noted that there are several versions of the Hypertext Transfer Protocol. The term Hypertext Transfer Protocol, HTTP, and/or similar terms are intended to refer to any version, now known and/or to be later developed. It is likewise noted that in various places in this document substitution of the term Internet with the term World Wide Web (“Web”) may be made without a significant departure in meaning and may, therefore, also be understood in that manner if the statement would remain correct with such a substitution.

Although claimed subject matter is not in particular limited in scope to the Internet and/or to the Web; nonetheless, the Internet and/or the Web may without limitation provide a useful example of an embodiment at least for purposes of illustration. As indicated, the Internet and/or the Web may comprise a worldwide system of interoperable networks, including interoperable devices within those networks. The Internet and/or Web has evolved to a self-sustaining facility accessible to potentially billions of people or more worldwide. Also, in an embodiment, and as mentioned above, the terms “WWW” and/or “Web” refer to a part of the Internet that complies with the Hypertext Transfer Protocol. The Internet and/or the Web, therefore, in the context of the present disclosure, may comprise a service that organizes stored digital content, such as, for example, text, images, video, etc., through the use of hypermedia, for example. It is noted that a network, such as the Internet and/or Web, may be employed to store electronic files and/or electronic documents.

The term “electronic file” and/or the term “electronic document” or the like are used throughout this document to refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

A Hyper Text Markup Language (“HTML”), for example, may be utilized to specify digital content and/or to specify a format thereof, such as in the form of an electronic file and/or an electronic document, such as a Web page, Web site, etc., for example. An Extensible Markup Language (“XML”) may also be utilized to specify digital content and/or to specify a format thereof, such as in the form of an electronic file and/or an electronic document, such as a Web page, Web site, etc., in an embodiment. Of course, HTML and/or XML are merely examples of “markup” languages, provided as non-limiting illustrations. Furthermore, HTML and/or XML are intended to refer to any version, now known and/or to be later developed, of these languages. Likewise, claimed subject matter are not intended to be limited to examples provided as illustrations, of course.

In the context of the present document, the term “Web site” and/or similar terms refer to Web pages that are associated electronically to form a particular collection thereof. Also, in the context of the present disclosure, “Web page” and/or similar terms refer to an electronic file and/or an electronic document accessible via a network, including by specifying a uniform resource locator (URL) for accessibility via the Web, in an example embodiment. As alluded to above, in one or more embodiments, a Web page may comprise digital content coded (e.g., via computer instructions) using one or more languages, such as, for example, markup languages, including HTML and/or XML, although claimed subject matter is not limited in scope in this respect. Also, in one or more embodiments, application developers may write code (e.g., computer instructions) in the form of JavaScript (or other programming languages), for example, executable by a computing device to provide digital content to populate an electronic document and/or an electronic file in an appropriate format, such as for use in a particular application, for example. Use of the term “JavaScript” and/or similar terms intended to refer to one or more particular programming languages are intended to refer to any version of the one or more programming languages identified, now known and/or to be later developed. Thus, JavaScript is merely an example programming language. As was mentioned, claimed subject matter is not intended to be limited to examples and/or illustrations.

As was indicated, in the context of the present disclosure, the terms “entry,” “electronic entry,” “document,” “electronic document,” “content,”, “digital content,” “item,” “object,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format). Likewise, in the context of the present disclosure, digital content provided to a user in a form so that the user is able to readily perceive the underlying content itself (e.g., content presented in a form consumable by a human, such as hearing audio, feeling tactile sensations and/or seeing images, as examples) is referred to, with respect to the user, as “consuming” digital content, “consumption” of digital content, “consumable” digital content and/or similar terms. For one or more embodiments, an electronic document and/or an electronic file may comprise a Web page of code (e.g., computer instructions) in a markup language executed or to be executed by a computing and/or networking device, for example. In another embodiment, an electronic document and/or electronic file may comprise a portion and/or a region of a Web page. However, claimed subject matter is not intended to be limited in these respects.

Also, for one or more embodiments, an electronic document and/or electronic file may comprise a number of components. As previously indicated, in the context of the present disclosure, a component is physical, but is not necessarily tangible. As an example, components with reference to an electronic document and/or electronic file, in one or more embodiments, may comprise text, for example, in the form of physical signals and/or physical states (e.g., capable of being physically displayed and/or maintained as a memory state in a tangible memory). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed and/or maintained as a memory state in a tangible memory). In an embodiment, digital content may comprise, for example, text, images, audio, video, haptic content and/or other types of electronic documents and/or electronic files, including portions thereof, for example.

Also, in the context of the present document, the term parameters (e.g., one or more parameters) refer to material descriptive of a collection of signal samples, such as one or more electronic documents and/or electronic files, and exist in the form of physical signals and/or physical states, such as memory states. For example, one or more parameters, such as referring to an electronic document and/or an electronic file comprising an image, may include, as examples, time of day at which an image was captured, latitude and longitude of an image capture device, such as a camera, for example, etc. In another example, one or more parameters relevant to digital content, such as digital content comprising a technical article, as an example, may include one or more authors, for example. Claimed subject matter is intended to embrace meaningful, descriptive parameters in any format, so long as the one or more parameters comprise physical signals and/or states, which may include, as parameter examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Signal packet communications and/or signal frame communications, also referred to as signal packet transmissions and/or signal frame transmissions (or merely “signal packets” or “signal frames”), may be communicated between nodes of a network, where a node may comprise one or more network devices and/or one or more computing devices, for example. As an illustrative example, but without limitation, a node may comprise one or more sites employing a local network address, such as in a local network address space. Likewise, a device, such as a network device and/or a computing device, may be associated with that node. It is also noted that in the context of this disclosure, the term “transmission” is intended as another term for a type of signal communication that may occur in any one of a variety of situations. Thus, it is not intended to imply a particular directionality of communication and/or a particular initiating end of a communication path for the “transmission” communication. For example, the mere use of the term in and of itself is not intended, in the context of the present disclosure, to have particular implications with respect to the one or more signals being communicated, such as, for example, whether the signals are being communicated “to” a particular device, whether the signals are being communicated “from” a particular device, and/or regarding which end of a communication path may be initiating communication, such as, for example, in a “push type” of signal transfer or in a “pull type” of signal transfer. In the context of the present disclosure, push and/or pull type signal transfers are distinguished by which end of a communications path initiates signal transfer.

Thus, a signal packet and/or frame may, as an example, be communicated via a communication channel and/or a communication path, such as comprising a portion of the Internet and/or the Web, from a site via an access node coupled to the Internet or vice-versa. Likewise, a signal packet and/or frame may be forwarded via network nodes to a target site coupled to a local network, for example. A signal packet and/or frame communicated via the Internet and/or the Web, for example, may be routed via a path, such as either being “pushed” or “pulled,” comprising one or more gateways, servers, etc. that may, for example, route a signal packet and/or frame, such as, for example, substantially in accordance with a target and/or destination address and availability of a network path of network nodes to the target and/or destination address. Although the Internet and/or the Web comprise a network of interoperable networks, not all of those interoperable networks are necessarily available and/or accessible to the public.

In the context of the particular document, a network protocol, such as for communicating between devices of a network, may be characterized, at least in part, substantially in accordance with a layered description, such as the so-called Open Systems Interconnection (OSI) seven layer type of approach and/or description. A network computing and/or communications protocol (also referred to as a network protocol) refers to a set of signaling conventions, such as for communication transmissions, for example, as may take place between and/or among devices in a network. In the context of the present disclosure, the term “between” and/or similar terms are understood to include “among” if appropriate for the particular usage and vice-versa. Likewise, in the context of the present disclosure, the terms “compatible with,” “comply with” and/or similar terms are understood to respectively include substantial compatibility and/or substantial compliance.

A network protocol, such as protocols characterized substantially in accordance with the aforementioned OSI description, has several layers. These layers are referred to as a network stack. Various types of communications (e.g., transmissions), such as network communications, may occur across various layers. A lowest level layer in a network stack, such as the so-called physical layer, may characterize how symbols (e.g., bits and/or bytes) are communicated as one or more signals (and/or signal samples) via a physical medium (e.g., twisted pair copper wire, coaxial cable, fiber optic cable, wireless air interface, combinations thereof, etc.). Progressing to higher-level layers in a network protocol stack, additional operations and/or features may be available via engaging in communications that are substantially compatible and/or substantially compliant with a particular network protocol at these higher-level layers. For example, higher-level layers of a network protocol may, for example, affect device permissions, user permissions, etc.

A network and/or sub-network, in an embodiment, may communicate via signal packets and/or signal frames, such via participating digital devices and may be substantially compliant and/or substantially compatible with, but is not limited to, now known and/or to be developed, versions of any of the following network protocol stacks: ARCNET, AppleTalk, ATM, Bluetooth, DECnet, Ethernet, FDDI, Frame Relay, HIPPI, IEEE 1394, IEEE 802.11, IEEE-488, Internet Protocol Suite, IPX, Myrinet, OSI Protocol Suite, QsNet, RS-232, SPX, System Network Architecture, Token Ring, USB, and/or X.25. A network and/or sub-network may employ, for example, a version, now known and/or later to be developed, of the following: TCP/IP, UDP, DECnet, NetBEUI, IPX, AppleTalk and/or the like. Versions of the Internet Protocol (IP) may include IPv4, IPv6, and/or other later to be developed versions.

Regarding aspects related to a network, including a communications and/or computing network, a wireless network may couple devices, including client devices, with the network. A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2nd, 3rd, or 4th generation (2G, 3G, or 4G) cellular technology and/or the like, whether currently known and/or to be later developed. Network access technologies may enable wide area coverage for devices, such as computing devices and/or network devices, with varying degrees of mobility, for example.

A network may enable radio frequency and/or other wireless type communications via a wireless network access technology and/or air interface, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, ultra-wideband (UWB), IEEE 802.11 (including, but not limited to, IEEE 802.11b/g/n), and/or the like. A wireless network may include virtually any type of now known and/or to be developed wireless communication mechanism and/or wireless communications protocol by which signals may be communicated between devices, between networks, within a network, and/or the like, including the foregoing, of course.

Although specific embodiments have been illustrated and described herein, any arrangement that achieve the same purpose, structure, or function may be substituted for the specific embodiments shown. This application is intended to cover any adaptations or variations of the example embodiments described herein. These and other embodiments are within the scope of the following claims and their equivalents, which are not limited by the examples presented in the specification.

1. A method of electronically processing a set of integrated electronic records for use, at least in part, in a non-integrated electronic environment, the method comprising:
accessing, via a communications network, at least one record of the set of integrated electronic records, the at least one record being in a first format;
electronically transforming the at least one record in the first format into at least one record in a second format compatible with the non-integrated electronic environment based, at least in part, on a parsing library predefined for the set of integrated electronic records;
creating a mapping of the at least one record in the first format to the at least one record in the second format based, at least in part, on a mapping design; and
converting the at least one record in the second format into a series of different formats comprising the mapping.

2. (canceled)

3. The method of claim 1, wherein the electronically transforming the at least one record comprises electronically transforming the record with minimum human intervention.

4. (canceled)

5. The method of claim 1, wherein the at least one record of the set of integrated electronic records comprises an encrypted record, and further comprising decrypting at least a portion of the encrypted record of the set of integrated electronic records.

6. (canceled)

7. (canceled)

8. (canceled)

9. The method of claim 1, wherein the electronically processing comprises one or more input validation operations to format the set of integrated electronic records and/or records for the non-integrated electronic environment, and wherein the one or more input validation operations comprise at least one of the following: a semantic-type validation operation, a syntactic-type validation operation, or any combination thereof.

10. (canceled)

11. (canceled)

12. (canceled)

13. The method of claim 1, wherein the mapping is implemented via a key linking the at least one record in the first format to the at least one record in the second format.

14. (canceled)

15. (canceled)

16. (canceled)

17. (canceled)

18. (canceled)

19. (canceled)

20. (canceled)

21. The method of claim 1, wherein the integrated electronic record comprises at least a portion of the EDI (Electronic Data Interchange) file, the EDI file comprising at least one file in one or more of the following formats: an HL7 format; an X12 format; a legacy file format; a legacy EDI format; or any combination thereof.

22. (canceled)

23. (canceled)

24. (canceled)

25. (canceled)

26. (canceled)

27. (canceled)

28. (canceled)

29. (canceled)

30. (canceled)

31. The method of claim 1, the mapping comprising at least one of the following: a one-to-many data record mapping; a many-to-one data mapping; or any combination thereof.

32. (canceled)

33. (canceled)

34. (canceled)

35. (canceled)

36. (canceled)

37. (canceled)

38. (canceled)

39. An apparatus comprising one or more processors coupled to a memory, the one or more processors to electronically process a set of integrated electronic records for use, at least in part, in a non-integrated electronic environment to:
access, via a communications network, at least one record of the set of integrated electronic records, the at least one record in a first format;
electronically transform the at least one record in the first format into at least one record in a second format compatible with the non-integrated electronic environment based, at least in part, on a parsing library predefined for the set of integrated electronic records;
create a mapping of the at least one record in the first format to the at least one record in the second format based, at least in part, on a mapping design; and
convert the at least one record in the second format into a series of different formats to comprise the mapping.

40. (canceled)

41. The apparatus of claim 39, wherein the electronically transforming the at least one record comprises electronically transforming the record with minimum human intervention.

42. (canceled)

43. The apparatus of claim 39, wherein the at least one record of the set of integrated electronic records comprises an encrypted record, and the one or more processors further operable to decrypt at least a portion of the encrypted record of the set of integrated electronic records.

44. (canceled)

45. (canceled)

46. (canceled)

47. The apparatus of claim 39, wherein the electronically processing comprises one or more input validations to format the set of integrated electronic records and/or records for the non-integrated electronic environment, and wherein the one or more input validation operations comprise at least one of the following: a semantic-type validation operation, a syntactic-type validation operation, or any combination thereof.

48. (canceled)

49. (canceled)

50. (canceled)

51. The apparatus of claim 39, wherein the mapping is implemented via a key linking the at least one record in the first format to the at least one record in the second format.

52. (canceled)

53. (canceled)

54. (canceled)

55. (canceled)

56. (canceled)

57. (canceled)

58. (canceled)

59. The apparatus of claim 39, wherein the integrated electronic record comprises at least a portion of the EDI (Electronic Data Interchange) file, the EDI file comprising at least one file in one or more of the following formats: an HL7 format; an X12 format; a legacy file format; a legacy EDI format; or any combination thereof.

60. (canceled)

61. (canceled)

62. (canceled)

63. (canceled)

64. (canceled)

65. (canceled) 66. (Canceled

67. (canceled)

68. (canceled)

69. The apparatus of claim 39, the mapping comprising a one-to-many data record mapping, a many-to-one data mapping, or any combination thereof.

70. (canceled)

71. (canceled)

72. (canceled)

73. (canceled)

74. (canceled)

75. (canceled)

76. (canceled)

77. A non-transitory storage medium having instructions executable by a processor to electronically process a set of integrated electronic records for use, at least in part, in a non-integrated electronic environment to:
access, via a communications network, at least one record of the set of integrated electronic records, the at least one record in a first format;
electronically transform the at least one record in the first format into at least one record in a second format compatible with the non-integrated electronic environment based, at least in part, on a parsing library predefined for the set of integrated electronic records;
create a mapping of the at least one record in the first format to the at least one record in the second format based, at least in part, on a mapping design; and
convert the at least one record in the second format into a series of different formats to comprise the mapping.

78. (canceled)

79. The non-transitory storage medium of claim 77, wherein the electronically transforming the at least one record comprises electronically transforming the record with minimum human intervention.

80. (canceled)

81. The non-transitory storage medium of claim 77, wherein the at least one record of the set of integrated electronic records comprises an encrypted record, and wherein the instructions to be executed by a processor are further to decrypt at least a portion of the encrypted record of the set of integrated electronic records.

82. (canceled)

83. (canceled)

84. (canceled)

85. The non-transitory storage medium of claim 77, wherein the electronically processing comprises one or more input validation operations to format the set of integrated electronic records and/or records for the non-integrated electronic environment, and wherein the one or more input validation operations comprise at least one of the following: a semantic-type validation operation, a syntactic-type validation operation, or any combination thereof.

86. (canceled)

87. (canceled)

88. (canceled)

89. The non-transitory storage medium of claim 77, wherein the mapping is implemented via a key linking the at least one record in the first format to the at least one record in the second format.

90. (canceled)

91. (canceled)

92. (canceled)

93. (canceled)

94. (canceled)

95. (canceled)

96. (canceled)

97. The non-transitory storage medium of claim 77, wherein the integrated electronic record comprises at least a portion of the EDI (Electronic Data Interchange) file, the EDI file comprising at least one file in one or more of: an HL7 format; an X12 format; a legacy file format; a legacy EDI format; or any combination thereof.

98. (canceled)

99. (canceled)

100. (canceled)

101. (canceled)

102. (canceled)

103. (canceled)

104. (canceled)

105. (canceled)

106. (canceled)

107. (canceled)

108. (canceled)

109. (canceled)

110. (canceled)

111. (canceled)

112. (canceled)

113. (canceled)

114. (canceled)
